(19) United States
(12) Patent Application Publication
(10) Pub. No.: US 2006/0245303 A1
(43) Pub. Date: Nov. 2, 2006

(54) Timer

(76) Inventor: Abraham Varon, Ramat Gan (IL)

Correspondence Address: DENNISON, SCHULTZ & MACDONALD, 1727 KING STREET, SUITE 105, ALEXANDRIA, VA, 22314, US

(21) Appl. No.: 10/554,422

(22) PCT Filed: Apr. 23, 2004
(86) PCT No.: PCT/IL04/00347

§ 371 Date: Oct. 24, 2005

(30) Foreign Application Priority Data
Apr. 24, 2003 (IL) 155549

(51) Int. Cl. G04F 8/00; G04F 10/00

(52) U.S. Cl. 368/109

(57) ABSTRACT

A timer including means for counting passage of a factory pre-set period of time according to a timing program required for a selected product, and an indicator for providing an indication at the end of the period of time to inform a user to take action.

### FIELD OF THE INVENTION

The present invention relates to timers, in general, and in particular, to timers for cosmetics, toiletries, and other uses which require a user to perform an activity for or after a fixed period of time.

### BACKGROUND OF THE INVENTION

The use of certain products or preparations in daily life requires time measurement. One example is hair color, which should be left for 20 minutes on the hair before rinsing. Another example is cosmetic face cream that should be left for 10 minutes on the face before removing. Yet another example is antibiotic medicine that should be taken every 8 hours. A further example is frozen foods, which must be cooked the precise amount of time or they become mushy. There are also recurring activities, such as gymnastics or physiotherapy, which must be carried out for a pre-selected period of time. Incorrect timing or scheduling in any of these cases will cause undesired results, and may lead to problems for the user or malfunctioning of the products.

Traditionally, the user would look at his watch at the beginning of the operation, and look occasionally at the watch in order to pinpoint the desired time for further action. This method is inconvenient, and there is no guarantee that one will not forget to look at his watch and miss the end of the measured time period.

Another option is to set an alarm clock or a table timer. This option is not optimal either, because a setup operation by the user is required, and because, during the measured time period, the user might change his location, e.g. move from one room to another, and not hear the alarm or timer ring.

Mobile timers are known, such as watches and cell phones which include an alarm or timer, and other small mobile timers exist. But all of these mobile wristwatches and timers require setup by the user before use, they are relatively expensive, and they are not common on a very wide scale. As a result, for example, a woman using hair colors currently does not have an optimal, suitable, convenient, inexpensive and practical means for the timing operation required.

Conventional timing devices for medicines include boxes with compartments where the medications are inserted according to the time or day of use. These generally do not include an alarm means. There are other medicine boxes that include a built-in timer. However, these are expensive devices (about 10 $), they are not mobile, and they must be set by the user. Therefore, they are not commonly used.

Accordingly, there is a long felt need for a convenient, reliable, portable timer, and it would be very desirable for it to be sufficiently inexpensive to be disposable after a single use or several uses.

### SUMMARY OF THE INVENTION

The present invention provides a mobile, electronic timer, which is dedicated for use with a specific product or preparation. It-is a very low cost device: the unit price might be around 5 to 15 cents. The device is extremely simple to use. No setup whatsoever by the user is required, as the timer is factory set for each specific product. The timer is preferably held on the body, as an armlet, bracelet or pendant, or in any other fashion.

There is thus provided, in accordance with the present invention, a timer including means for counting passage of a factory pre-set period of time according to a timing program required for a selected product, and an indicator for providing an indication at the end of the period of time to inform a user to take action.

The indicator may provide audio signals or visual signals. Thus, the timer can indicate the end of the pre-set period by playing a melody, a series of beep tones, a flashing light, or any other audio or visual signal or, alternatively, by ceasing a continuous signal.

According to a preferred embodiment, the timer includes a printed circuit board (PCB) with a chip-on-board having a dedicated timing program for providing signals in accordance with the timing program, a switch for activating the timing program, and an internal power source, such as a battery, for powering the timer.

The timer has several special features. First, it is dedicated for use with a specific product or preparation, and will be supplied usually in the packaging together with that product or preparation. Second, the timer is designed for the life span of the related preparation or product, so that battery replacement will not be needed. The timer can be used for only a limited time or number of times. Thus, it may be used once, e.g., if sold within a hair color kit, or dozens of times, as when sold with a face mask package.

Third, the timer of the invention is simple to operate. No setup by the user is required, merely activation by means of a single button or other operating means. Fourth, the timer is inexpensive to manufacture, and is sufficiently small that it can be carried on the body.

The use of the timer of the invention is also very simple. An example of a typical use is as follows: After using the related product or preparation, e.g. spreading hair color on the head, the user pushes the single activation button or switch. Preferably, the user wears the timer on his hand or around his neck or just puts it near him. A few tones, such as a short melody or a few beep sounds, optionally may indicate that the device has started to operate. At the end of the pre-set measured period of time, e.g. 20 minutes for a certain kit of hair colors, a different melody or another arrangement of beep sounds may be played. Alternatively, a melody may be played from the time of activation until the pre-set period of time has expired, at which time the melody stops. This indicates to the user that the time has passed and hair rinsing is required.

There are three options regarding the duration of the signal which indicates the end of the measured period of time and the way it is terminated. Option a: at the end of the measured time period, the signal starts to play and continues for a pre-defined period, and then stops automatically. Option b: at the end of the measured time period, the signal starts to play and continues to play until the user pushes the button again. Option c: A combination of a and b: the signal stops after a specific sound or light sequence, or when the user pushes the button—whichever comes first.

It will be appreciated that option b is safer than options a and c, because it ensures that the user will notice the end of time signal and not ignore it. For example, suppose the user puts down the bracelet timer for a while, and just during this time the signal for the end of the measured period of time sounds. Or if there is a loud noise, e.g. a passing airplane, exactly at the time the signaling occurs. Even in these cases, the user would not miss the signal, because the timer keeps signaling until the user pushes the button.

According to an alternative option, the signals may be the opposite of that indicated above. That is, a tune or light signals may be played during the entire measured time, instead of starting at the end of the measured time. For example, a melody or a series of beep sounds in short gaps may play from the time of activation of the timer throughout the entire measured period. When the signals stop automatically, it indicates the ending of the measured period. In this case, the device is constantly signaling from the moment of operation until the end of the measured period of time.

There is a further option that, in addition to the signaling at the start and at the end of the measured time, the timer will sound at fixed intervals in between. For example, the timer may provide 1 or 2 beep sounds each minute. These signals are just a reminder of the fact that the time measurement is in process. In order to prevent confusion with the signal of the end of the pre-measured time, these intermediate signals will be different. For example: a single beep sound every minute, as opposed to a melody or a long series of beep sounds at the end, and which continues until the user pushes the button. Using slightly more expensive components, the sound signal can be spoken words.

The use of tunes (beeps, melody) as a signal can be replaced with light, i.e. using a visual signal instead of a sound signal. This can be a constant light or a blinking light. This solution maintains the same low cost and functional simplicity of the timer. This solution is good for people with hearing difficulties, as well as to people who prefer a silent device. The operation is based on the same principle: Once the button is pushed, a few blinking lights appear, indicating the start of time measurement. At the end of the time measurement, the light starts blinking again, until the button is pushed. Alternatively, the timer may flash during the entire measured time, and then stop flashing automatically at the end of the measured period of time.

The examples above referred to cosmetics and toiletry. Another application of the device is for taking medicines. One example is antibiotics that should be taken every 8 hours, for 5 days (a total of 15 doses). The timer will be supplied with the medicine, and may constitute a bracelet to be worn on the user's arm. One push activates the timer, which signals a few beep sounds. Starting this moment, every 8 hours the timer starts signaling with tunes or beep sounds. This reminds the user to take the medicine. Pushing the button will stop the tunes for the next 8 hours, at which time the timer starts signaling again. This process continues for 15 times, until the last dose is taken. Again, this is a dedicated timer, with a factory setup tailored to the medication to which it is attached. It can be carried on the body, and it is extremely simple to use—one button to push, with no user setup required. It is so inexpensive to manufacture that it can be considered as a disposable device, supplied with the medicine, and thrown into the garbage or recycled at the end of use.

It is a particular feature of the invention that the electronic components may be easily sealed to provide a waterproof timer. For example, a nylon cover may be provided around all the electronic elements before they are inserted into the packaging or housing. This permits the user to wear the timer even when bathing.

### BRIEF DESCRIPTION OF THE DRAWINGS

The present invention will be further understood and appreciated from the following detailed description taken in conjunction with the drawings in which:

FIG. 1 is a flow chart of operation of a timer constructed and operative in accordance with one embodiment of the present invention;

FIG. 2 is a flow chart of operation of a timer constructed and operative in accordance with another embodiment of the present invention;

FIG. 3 is a flow chart of operation of a timer constructed and operative in accordance with a further embodiment of the present invention;

FIG. 4 is a flow chart of operation of a timer constructed and operative in accordance with yet another embodiment of the present invention;

FIG. 5a is an exploded view of a timer constructed and operative in accordance with one embodiment of the present invention;

FIGS. 5b and 5c are isometric and front sectional views, respectively, of the timer of FIG. 5a;

FIG. 6a is an exploded view of a timer constructed and operative in accordance with another embodiment of the present invention;

FIGS. 6b and 6c are isometric and front sectional views, respectively, of the timer of FIG. 6a;

FIG. 7a is an exploded view of a timer constructed and operative in accordance with a further embodiment of the present invention;

FIGS. 7b and 7c are isometric and front sectional views, respectively, of the timer of FIG. 7a;

FIG. 8a is an exploded view of a timer constructed and operative in accordance with a further embodiment of the present invention; and

FIGS. 8b and 8c are isometric and front sectional views, respectively, of the timer of FIG. 8a.

### DETAILED DESCRIPTION OF THE INVENTION

The present invention relates to a mobile, functional timer, that is dedicated for each type of use, and which is disposable. This is a compact and very low cost electronic device, for the purpose of timing of routine activities in daily life, particularly those involving the use of various products or preparations requiring specific timing. This timer will prevent malfunction of the products and trouble for the user, which are very common today, whenever people forget to follow the timing procedure while using specific products. Due to the simplicity of use and the relatively low price of the timer of the present invention, such a timer can be incorporated into all the daily-based events for which there is no available, convenient and efficient solution today.

These characteristics are made possible by the simple structure of the timer, which requires a smaller number of operations for assembly than conventional timers, and which utilizes relatively inexpensive components. Thus, the timer of the invention includes an electronic timing unit seated in compact packaging. The electronic timing unit preferably includes the following components:
a. A printed circuit board assembly (PCB) with a Chip-On-Board that generates signals when operated, based on a factory preset timing program (internal programming).
b. A switch: an operating button or another type of trigger to activate the timer and start the operation.
c. Signaling means, such as piezo speaker (a very thin speaker) or another type of speaker, or a steady or blinking light, such as a LED or Micro Bulb.
d. A small battery, such as 1.5 Volt LR41 or LR 1130, or any other inexpensive small cell.

Once the switch is operated, the PCB unit starts counting the pre-set time. The PCB unit is programmed to generate the tunes or light signals (provided by the signaling means) at the end of the measured time, or alternatively, during the entire measured time. For a timer that generates the signals at the end of the measured time, these signals are stopped by pushing the switch button again, or they may stop automatically after a specific signals sequence. Another option is a combination of these two options: The sounds may stop when the user pushes the switch, or automatically after a specific signals sequence—whichever comes first. In addition, the PCB unit may generate signals at the start of operation and\or periodically throughout the measured time to indicate that time counting is in progress.

The compact packaging is preferably a compact plastic or cardboard housing for the electronics. The housing may include a plastic bracelet or armlet, or band or rubber band that can be put around the arm or leg, or a lace or ribbon that can be hung around the neck, or just a compact packaging to be put in a pocket or on a table.

It is a particular feature of the invention that the electronic components may be easily sealed to provide a waterproof timer. For example, a nylon cover may be provided around all the electronic elements. Then the timer can be worn on the arm or around the neck for several days as required, and need not be removed even when bathing. (This nylon sealing barely affects the price of the timer, which might be between 5 and 15 cents.)

The switch may be a standard contact switch, which closes a circuit when pushed. Another option would be to replace a standard switch with an electronic switch based on a sensor, for example, a light sensitive sensor (a standard component that closes a circuit when exposed to light). In this case, there is no button to be pushed. Rather, an element that prevents light from reaching the sensor is removed in order to activate the sensor. One example is dark, opaque adhesive tape. This tape is mounted on the packaging over the light sensor window. Once the tape is moved or removed, the sensor is exposed to light, and the time counting begins.

The method of operation will now be described by way of several non-limiting examples.

### EXAMPLE 1

This example relates to a timer for a product that requires a single time measurement per operation, for example, a face mask, which should remain on the face for 10 minutes.
a. After spreading the mask on the face, the timer is placed on the user's hand, or placed near him or her.
b. The push button is pressed or the timer is activated in another manner. Two beep sounds optionally indicate that the timing operation has started.
c. Optionally, every 1 minute a single beep sound is heard. This occurs for the next 9 minutes.

It will be appreciated that, during this time, pushing the button again will not change anything. The timer is in the process of counting the time, and stopping it or resetting it is impossible during this stage.
d. At the end of 10 minutes, the device starts playing a tune, or a sequence of beep sounds. At this stage, pushing the button stops the sounds. An alternative approach is to allow the sounds to stop without pushing the button, after a certain period of time, e.g. 1 minute. This tune or beep sounds sequence reminds the user to wash the face mask off the face.
e. The device is ready for its next use.

### EXAMPLE 2

This example relates to a timer for a product that requires a repetitive sequence of time measurements, e.g. for taking three antibiotic pills per day for five days (15 pills).
a. After taking the first pill, the timer is placed on the user's hand, neck, or in a pocket.
b. The push button is pressed or the timer is activated in another manner (for example, tearing the seal on the pills for the first time shorts the circuit of an attached timer's switch, and activates the timer). Two beep sounds optionally indicate that the timing operation has started.
c. Optionally, every 1 hour a single beep sound is heard. This occurs for the next 7 hours.

As in the case of Example 1, once the button has been pressed and the timer activated, further pressure on the button will have no effect on the timer.
d. At the end of 8 hours, the timer starts playing a melody or a sequence of beep sounds to remind the user to take another pill. At this stage, pushing the button stops the sounds, and another 8 hours count starts automatically.
e. After the timer has counted 14 cycles of 8 hours each, the timer stops.
f. The device is ready for another use, or alternatively can be thrown out or recycled.

If desired, the tune at the time of taking the last (15^{th}) dose may be different than the tune for the previous 14 doses.

Alternatively, using a slightly more expensive chip and speaker, the tunes can be replaced with speaking, i.e. the device may, for example, say: “pill one” after 8 hours, “pill two” after another period of 8 hours, etc.

### EXAMPLE 3

This example relates to a timer for a product that requires a preparation that involves multi-stage time counting. For example, certain hair color products require two stages having different timing: after spreading the hair color, a 20 minute wait is required. At that time, the hair must to be combed and possibly additional color added to spots, such as temples, which are difficult to color. Then another 10 minutes wait is required, followed by hair rinsing.

After putting on the hair color, the timer is placed on the user's hand, or near the user.

The push button is pressed or the timer is activated in another manner. Two beep sounds optionally indicate that the timing operation has started. Optionally, every 1 minute a single beep sound is heard. This occurs for the next 20 minutes.

At the end of the 20 minutes, the timer begins to flash or provides another visual or audible signal to remind the user to comb her hair. At this stage, pushing the button stops the signals or, alternatively, the timer may be programmed to stop the signals automatically after a certain period of time. The timer now starts the count for the second stage timing. Optionally, every minute a single beep sound continues to be heard. This occurs for the next 9 minutes.

At the end of 10 minutes, the device again begins to flash, or provide a signal, this time to remind the user to rinse her hair. Pushing the button stops the signals, or the timer may be programmed to stop the signals automatically after a certain period of time, e.g. 1 minute.

The timer is now ready for its next use, or alternatively may be tossed out or recycled.

### EXAMPLE 4

This example relates to a timer for a product that requires a single time measure per operation. In this example, the tinier is programmed to provide a continuous signal during the entire counting period and then to stop. One example of a suitable use is a hair remover, which must remain on the body for 5 minutes.

After spreading the hair remover on the hairy skin, the timer is placed on the user's hand, around his neck, or otherwise near the user.

The push button is pressed or the timer is activated in another manner.

A continuous signal or sequence of signals is provided. Thus, a sequence of tunes may be played, such as a melody or a sequence of beep sounds, or alternatively the signal can be a light on or a blinking light. This continues for 5 minutes.

If desired, the signal near the end of the pre-set time period may differ from the signal at the start. For example, the timer may signal with a beep sound every 2 seconds during 4 minutes and 50 seconds, and then play a 10 second melody to conclude the 5 minutes of time measuring.

At the end of the 5 minutes, the melody or the tune or the light stops. This is the indication to the user that the hair remover preparation should be wiped off the skin, and that the device is ready for a next use.

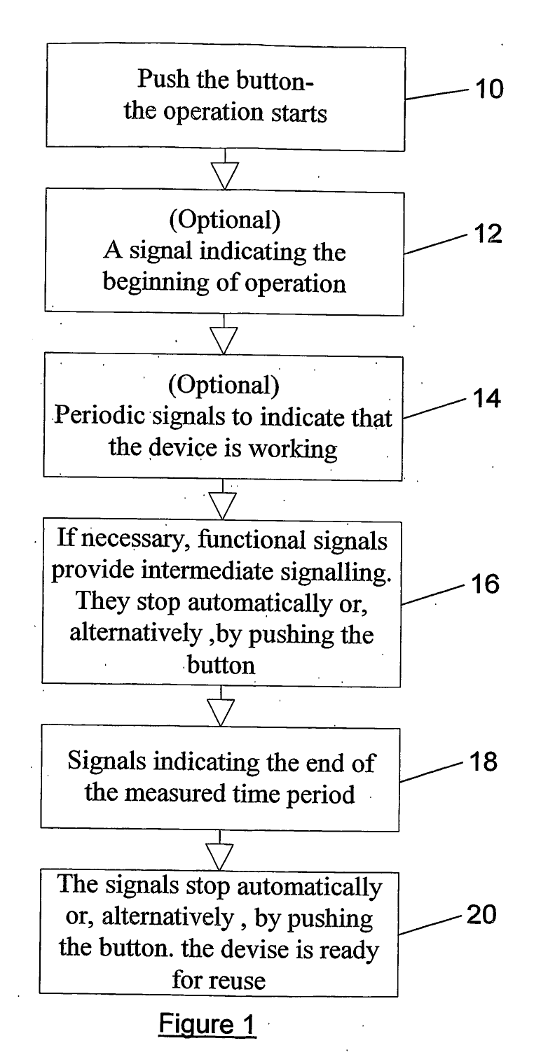

Referring now to FIGS. 1, 2 and 3, there are shown flow charts of the operation of a timer constructed and operative in accordance with three embodiments of the present invention. Each of these flow charts or methods of operation may be used in any of the examples above.

In FIG. 1, operation of the timer starts with the push of the button (block 10). Optionally, a signal may indicate the activation of the timer (block 12). Intermediate signals to indicate that the device is working may optionally be produced (block 14). Functional intermediate signals are provided (block 16), for products which require several timing stages. (This means that the signal for time termination appears at least twice (and could be more than twice), depending upon the number of stages.) These intermediate signals may be stopped by the user pressing the activation button, or automatically at the end of a selected signal sequence. Once the total factory set measured time period has expired, signals are provided indicating that the time has expired (block 18) and the user must act accordingly. After these signals have been generated, the signals stop and the timer is ready for reuse (block 20). The signals may be stopped by the user pressing the activation button, or automatically at the end of a selected signal sequence.

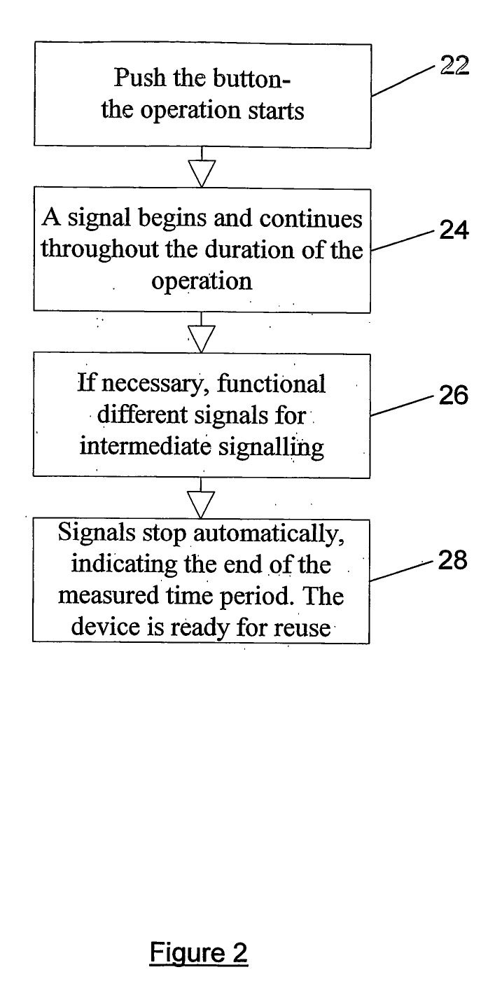

The flow chart of FIG. 2 shows an alternative method of operation of the timer. In the embodiment of FIG. 2, operation of the timer starts with the push of the button (block 22). In response, a signal indicating ongoing measurement of time is generated, which continues throughout the duration of operation of the timer (block 24), e.g., playing a continuous melody, until the end of the measured time period. If required, different signals may be generated to indicate counting the time of an additional stage (block 26). At the end of the pre-set period of time, the signals stop (block 28). The timer is now ready for reuse.

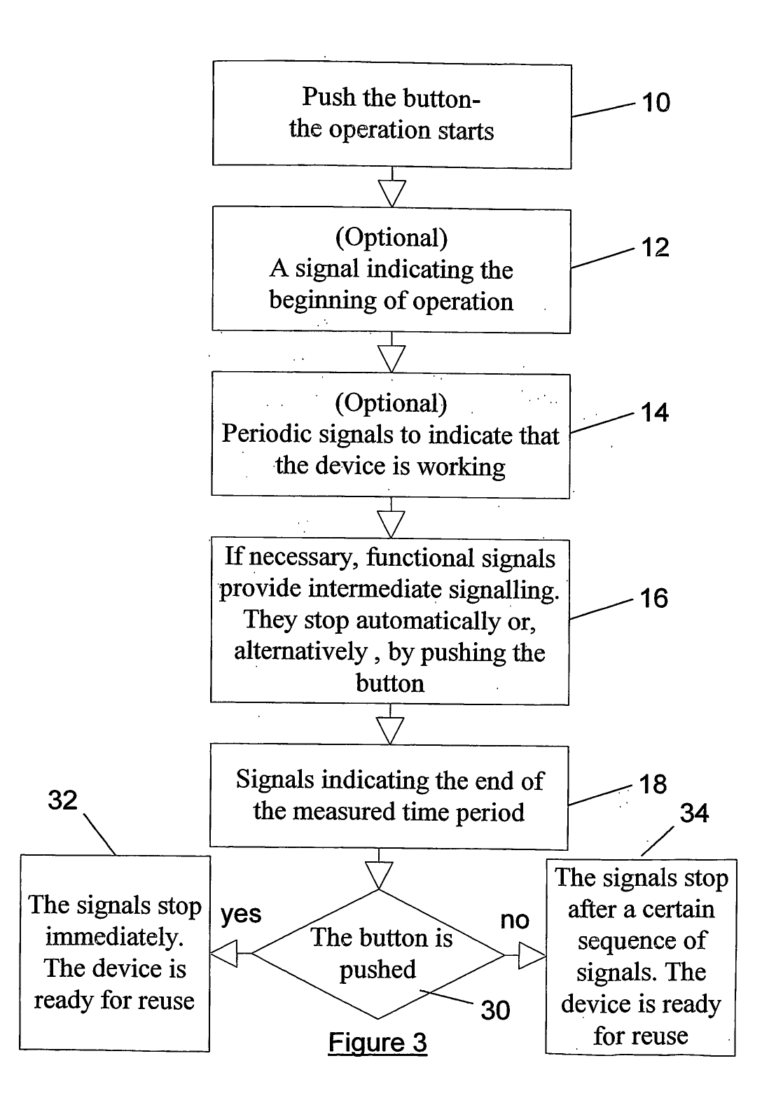

The flow chart of FIG. 3 is substantially similar to that of FIG. 1, and like elements have like reference numerals. Operation of the timer starts with the push of the button (block 10). An optional signal may indicate the activation of the timer (block 12). Intermediate signals to indicate that the device is working may optionally be produced (block 14). Functional intermediate signals are provided (block 16), for products which require several timing stages. Once the total factory set measured time period has expired, signals are generated indicating that the time has expired (block 18) and the user must act accordingly. After these signals have been generated, the chip-on-board determines whether the activation button has been pushed again (block 30). If the button has been pushed, the signals stop and the timer is ready for reuse (block 32). If the button has not been pushed, the signals stop automatically after a pre-selected length of time, and the timer is ready for reuse (block 34). While it is not shown in FIG. 3, the same methods for stopping the signals as described in blocks 30, 32, 34 may be utilized to stop the intermediate signals provided in block 16.

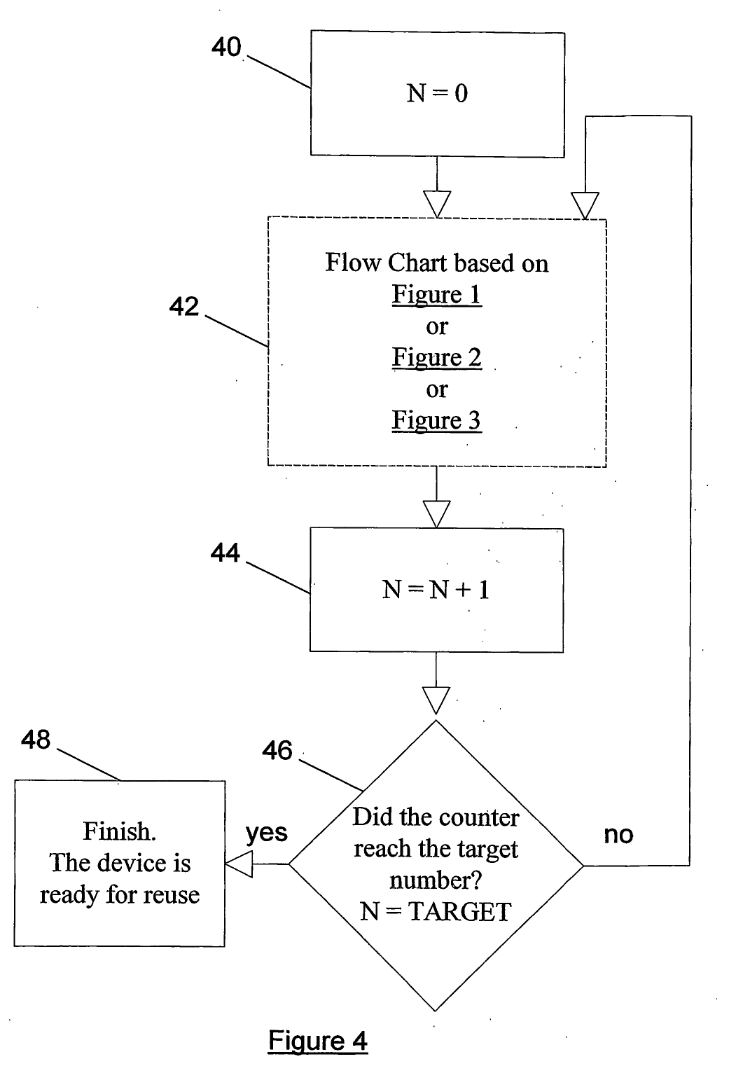

FIG. 4 represents Example 2 above, including a repetitive sequence of time measurement. This flow chart is based on any of FIGS. 1, 2 or 3. At the start of operation, a counter is set to N=0, where N is the target or required number of operations (i.e., 15 pill taking operations) (block 40). Once the signals stop (at the end of block 42), the counter increases by 1 to N+1 (block 44). The chip determines whether the counter reached the target number N (block 46). If not, operation of the timer is begun again automatically by the chip (block 44). When the target number is reached, the signals stop and the timer is ready for reuse (block 48).

The timer of the present invention includes packaging which preferably permits the timer to be worn on the body of a user, and electronics, which may include a printed circuit board (PCB) with a chip-on-board. The chip is pre-programmed with a dedicated timing program for providing signals in accordance with the timing program. The timer also includes a switch for activating the timing program, and a battery for powering the timer. The timer may be programmed for measuring a single time period or a series of time periods with equal or not equal lengths, and alerting a user to the ending of each measured time period by activating or deactivating of tunes and or sound and or light.

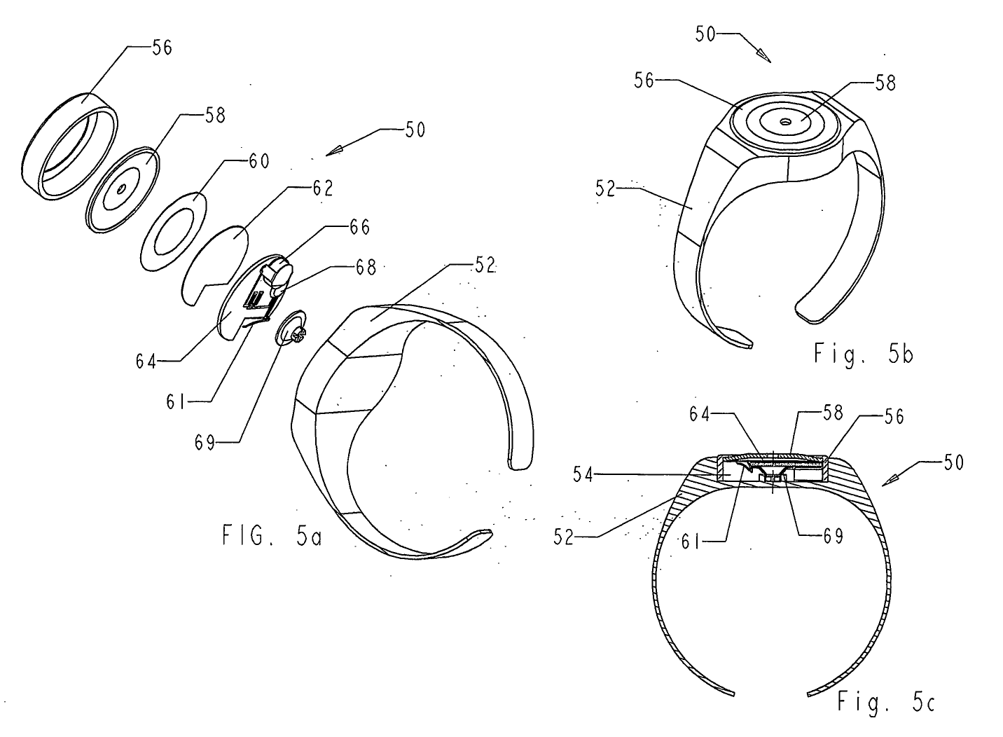

The invention can be applied in various embodiments, a few of which will now be described by way of non-limiting example. Referring now to FIGS. 5a, 5b and 5c, there are shown exploded, isometric, and front sectional views, respectively, of a timer 50 constructed and operative in accordance with one embodiment of the present invention. Timer 50 includes packaging in the shape of an elastic bracelet 52 defining a socket 54. The bracelet 52 is preferably formed of flexible plastic or cardboard, or another relatively inexpensive material. A cover 56 is constructed and adapted to enclose the electronics and seat in socket 54.

The electronics of the timer are seated in socket 54. The electronics includes means for counting passage of a factory pre-set period of time. The timer 50 includes a switch and an indicator, here illustrated as a speaker 60. A speaker housing 58 is seated in cover 56. Speaker housing 58 is arranged to hold a speaker 60 and acts as an acoustic box for the speaker. Speaker 60 is affixed to a printed circuit board (PCB) assembly 64, as by means of double sided tape 62. PCB assembly 64 includes a cell battery 66 in a battery housing, a factory programmed chip on board 68, and wiring for the speaker 61. Disposed between PCB assembly 64 and bracelet 52 is a spring-like rubber element 69 having a conductive member or coating in the middle. Rubber element 69 acts like a spring and is used as a switch to activate chip 68 on the PCB. Speaker housing 58 serves as a button which a user can press to urge conductors on the face of the PCB against the conductive material in the center of element 69. This shorts the circuit and activates the chip on board to begin counting the time.

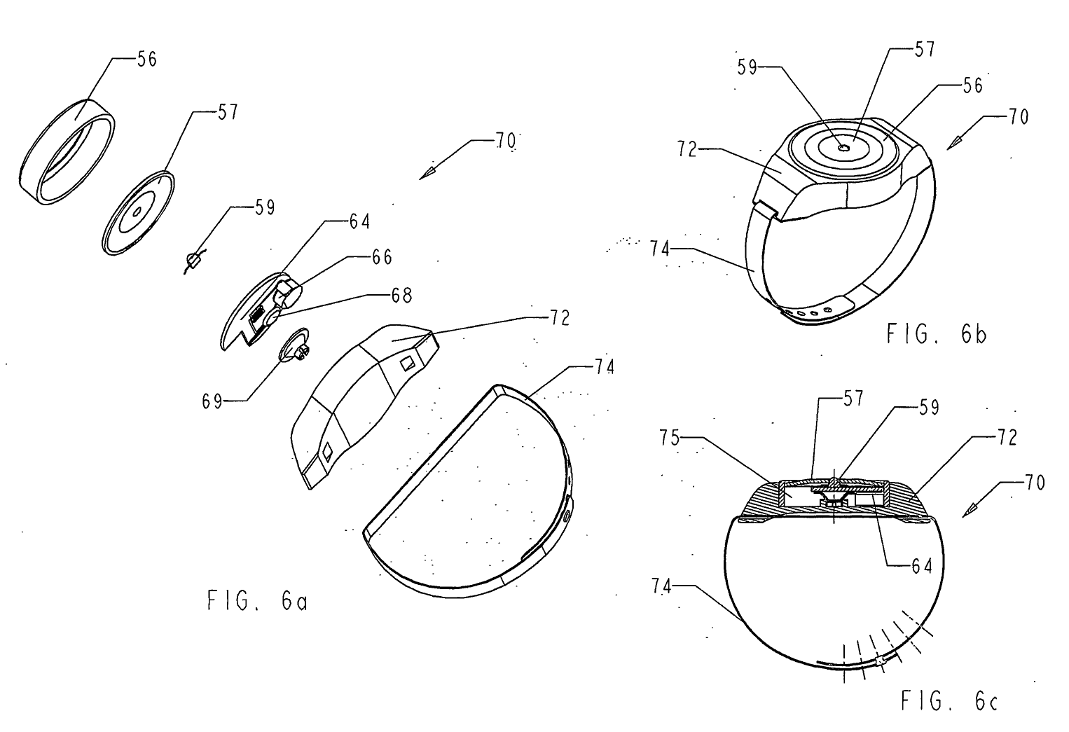

Referring now to FIGS. 6a, 6b and 6c, there are shown exploded, isometric and front sectional views, respectively, of a timer 70 constructed and operative in accordance with another embodiment of the present invention. Timer 70 includes packaging having a housing 72 and a flexible plastic band 74 couplable to housing 72 for wearing on the user's arm or leg. The housing 72 includes a socket 75 arranged to be closed by cover 56 for holding the electronics, and is preferably formed of flexible plastic or cardboard, or another relatively inexpensive material, as is the band.

The electronics in the embodiment of FIG. 6a includes a switch and an indicator substantially the same as those in FIG. 5a. Similar elements have the same reference numerals and will not be described again. The indicator or signal provider in this embodiment is not a speaker, but a LED or micro bulb lamp 59, which is covered by a lamp housing 57. The lamp housing is designed to be used as a button to urge conductors on the face of the PCB against conductive material in the center of switch 69. It will be appreciated that lamp housing 57 and cover 56 have a central aperture to permit the light to be seen outside the packaging.

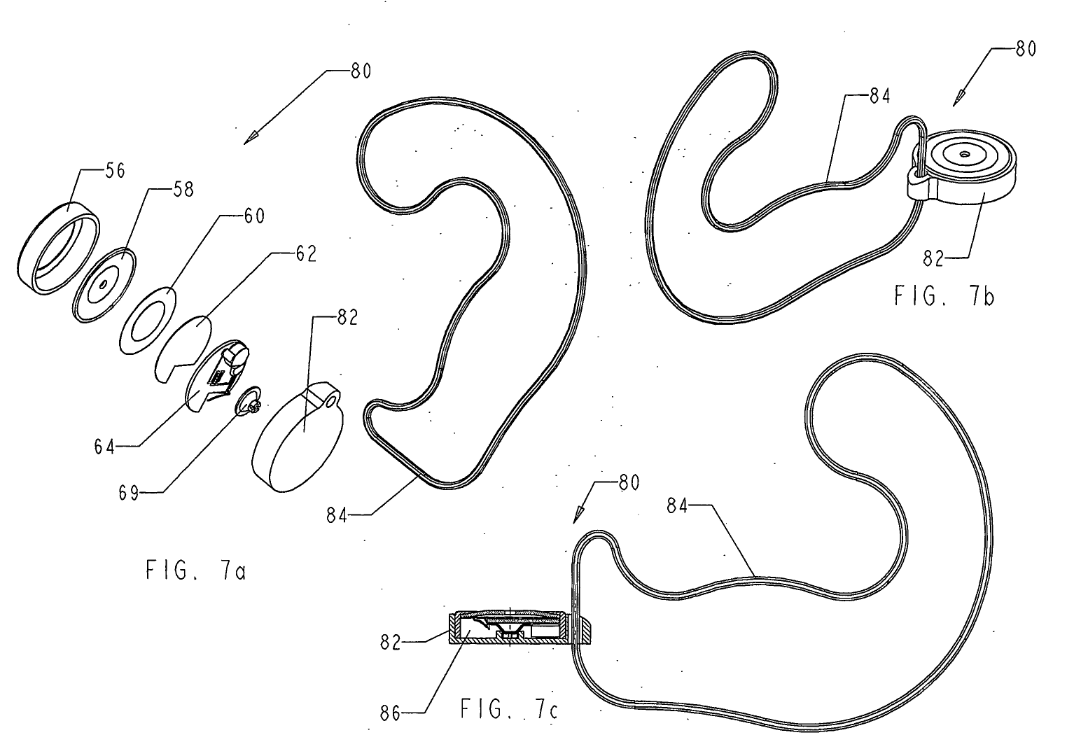

According to an alternative embodiment of the invention, the timer may be worn around the user's neck, instead of on an arm or leg. One such device is shown in FIGS. 7a, 7b and 7c, respective exploded, isometric and front sectional views of a timer 80 constructed and operative in accordance with a further embodiment of the present invention. In this embodiment, the electronics is substantially the same as that in FIG. 5a, but the packaging includes a pendant 82 and means 84 for hanging the pendant around the user's neck. Means 84 may be a lace, a ribbon, or an elastic band, or any other suitable means for hanging pendant 82. Pendant 82 includes a socket. 86 adapted to be closed by cover 56 for holding the electronics.

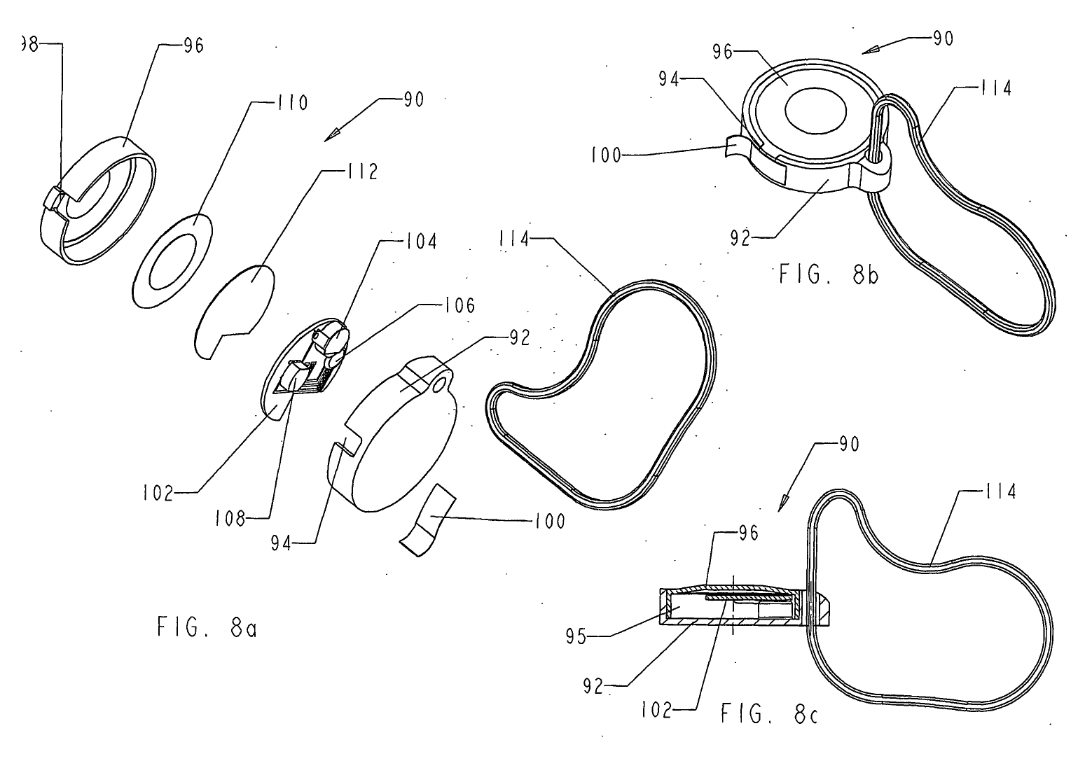

As stated above, the timer can include a sensor switch, as opposed to a mechanical switch, as illustrated in FIGS. 5a, 6a and 7a. With reference to FIGS. 8a, 8b and 8c, there are shown respective exploded, isometric, and front sectional views of a timer 90 constructed and operative in accordance with a further embodiment of the present invention. Timer 90 includes packaging 92 having a window 94. Packaging 92 is illustrated in FIG. 8a as a pendant, but can, alternatively, be any other packaging suitable for wearing on the arm, leg or other portion of the body of a user. Packaging 92 includes a socket 95 for holding the electronics, and is closed by a cover 96. Cover 96 also includes a window 98 arranged for assembly in registration with window 94 of packaging 92. Removable opaque adhesive tape 100 is placed over windows 94 and 98 when the timer is not in use.

Timer 90 further includes electronics comprising means for counting passage of a factory pre-set period of time and an indicator, and is adapted to seat in socket 95 in packaging 92. The electronics include a printed circuit board (PCB) assembly 102 including a cell battery 104 in a battery housing, a factory programmed chip on board 106, wiring for a speaker (not shown) and a light-sensitive sensor 108 which functions as an electronic switch. Light sensitive sensor 108 is disposed adjacent window 98. In this embodiment, cover 96 is arranged to hold a speaker 110 and acts as an acoustic box for the speaker. Speaker 110 is affixed to PCB assembly 102, as by means of double sided tape 112. Cover 96 is disposed in packaging 92 in such a way that window 98 is adjacent window 94. When the opaque adhesive tape 100 is removed from the window 94, light can enter packaging 92 via windows 94 and 98, causing the light-sensitive sensor 108 to activate the chip on board to begin counting the time.

This embodiment can also be provided with an elastic band 114 or ribbon for wearing the timer about the neck, arm or leg or the user.

According to an alternative embodiment of the invention, the opaque adhesive tape may be replaced by a slider. The slider can be moved between a first position, wherein it closes the windows 94 and 98, thereby preventing the entrance of light into the packaging, and a second position, wherein windows 94 and 98 are open; thereby permitting the entrance of light to activate the light-sensitive sensor.

It is a particular feature of the present invention that the timer structure is very inexpensive. The typical cost of a timer according to the invention can be about 10 cents. Thus, the timer can be tossed into the garbage or recycled, after use.

While in the above applications, activation of the timer is accomplished manually by the user, it will be appreciated that the timer can alternatively be activated automatically when the product, or container holding the product, is opened or torn. The opening operation may automatically actuate the switch, or expose a light sensitive sensor to the light.

It will be appreciated that the configuration of the switch, spring, PCB, etc. is not limited to those illustrated, because the electronics and mechanics can be implemented in various simple manners, and may be based on technology and/or components used in toys and inexpensive electronic fun products. The timer of the invention combines inexpensive electronics with a functional timing program that is for a specific product or activity, and combining them in a functional packaging which can, if desired, be worn on the user's body. Together, the result is an effective and innovative high-tech aid. It has a very high benefit to cost ratio, which makes it disposable. It also has a very high ratio of benefit to simplicity of use, which makes it extremely useful and user friendly, requiring no user setup, and it solves a real need that has not been solved until now.

Since the device is so inexpensive, it can be enclosed with a large variety of products as a part of the product's kit or packaging. For example, a hair color kit that contains color, gloves and rinsing liquid may include a timer bracelet as well. The timer hardly affects the total consumer price because it has an almost negligible cost comparing to the related product's cost. The device is disposable and can be thrown away with the other waste products at the end of use.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A timer comprising:
means for counting passage of a factory pre-set period of time according to a timing program required for a selected product; and
an indicator for providing an indication at the end of said period of time to inform a user to take action.

2. The timer according to claim 1, wherein said means for counting is an electronic means which can be activated manually to count passage of a pre-set time.

3. The timer according to claim 1, wherein said means for counting is constructed and adapted to count more than one factory pre-set period of time according to said timing program.

4. The timer according to claim 3, wherein said means for counting is constructed and adapted to count a factory pre-set period of time a pre-set number of times, according to said timing program.

5. The timer according to claim 3, wherein said means for counting is constructed and adapted to count more than one factory pre-set period of time of unequal length, according to said timing program.

6. The timer according to claim 1, wherein said timer is activated automatically when said product is opened.

7. The timer claim 1, wherein said indicator provides an audible indication.

8. The timer according to claim 1, wherein said indicator provides a visual signal.

9. The timer according to claim 1, wherein said indicator provides a signal at the end of said pre-set period for a given period and then stops automatically.

10. The timer according to claim 1, wherein said indicator provides a signal at the end of said pre-set period until a switch is pushed.

11. The timer according to claim 1, wherein said indicator provides a signal at the end of said pre-set period until said a switch is pushed, or until the end of a specific sound or light sequence, whichever happens first.

12. The timer according to claim 1, wherein said switch and said indicator are sealed to provide a waterproof timer.

13. The timer according to claim 12, wherein said switch and said indicator are enclosed in a nylon cover.

14. The timer according to claim 1, wherein said timer is disposable after a single use.

15. The timer according to claim 1, wherein said means for counting passage of time includes:
a printed circuit board (PCB) with a chip-on-board having a dedicated timing program for providing signals in accordance with the timing program;
a switch for activating said timing program; and
an internal power source for powering the timer.

16. The timer according to claim 1, wherein said switch is an electronic switch and includes a light-sensitive sensor. switch and includes a light-sensitive sensor.

17. The timer according to claim 1, further comprising packaging adapted to be worn by a user.

18. The timer according to claim 1, wherein the indicator provides an indication at the start of counting the time period.

19. The timer according to claim 1, wherein the indicator provides an indication periodically during counting of the time period.

20. The timer according to claim 1, further comprising a manually actuated operating switch.

21-23. (canceled)

24. A method for providing an indication at the end of a period of time to inform a user to take action, the method comprising:
providing a timer including means for counting passage of a factory pre-set period of time according to a timing program required for a selected product;
providing means for activating said timer to begin counting; and
causing an indicator to provide an indication at the end of said period of time to inform the user to take action.
